(19) United States
(12) Patent Application Publication
(10) Pub. No.: US 2026/0232539 A1
(43) Pub. Date: Aug. 13, 2026

(54) A MODULAR ENTERAL FEEDING PUMP

(71) Applicant: ROCKFIELD MEDICAL DEVICES LIMITED, Galway (IE)

(72) Inventors: Donal MAYNE, Galway (IE); Tomas THOMPSON, Galway (IE); John KELLY, Galway (IE); Warner FIGUERAS, Galway (IE); Jonathan HIGGINS, Galway (IE)

(73) Assignee: ROCKFIELD MEDICAL DEVICES LIMITED, Galway (IE)

(21) Appl. No.: 19/471,704

(22) PCT Filed: Mar. 25, 2024
(86) PCT No.: PCT/EP2024/058000

§ 371 Date: Oct. 2, 2025

(30) Foreign Application Priority Data
Apr. 5, 2023 (EP) 23166742.9

(51) Int. Cl. A61J 15/00

(52) U.S. Cl. CPC A61J 15/0076

(57) ABSTRACT

An enteral feeding device has a shell having a neck and a module which is insertable into the shell. The module has a coupler which is releasably engageable with the neck, such as by push fitting until there is snap-fitting. The module has at a proximal end a spout and at a distal end an expansile reservoir configured to expand when filled to fit within a volume of the shell. The shell is pear shaped to match shape of the reservoir when full.

The present invention relates to enteral feeding.

Examples of such feeding systems are described in our published PCT Specification Numbers WO2017/140731, WO2018/108337, and WO2019/238773.

Enteral feeding or tube feeding is used worldwide by people who are unable to voluntarily eat or swallow food. Enteral feeding delivers the required nutrition to these people using a pump driven electrically from a mains supply or a battery. The pump administers a prescription formula directly into the stomach or nasal system, through a tube which is surgically inserted.

A PEG (Percutaneous Endoscopic Gastronomy) is a fixture which is inserted into a patient's stomach which allows a feeding tube coming from a pump to be attached for feeding to commence. Some of the reasons why patients require a PEG are head trauma, stroke, collagen vascular disorder and cancers such as head, throat or oesophageal. Other reasons behind requiring enteral feeding include needing to gain weight pre and post operation for people who can't get the required calories from their normal diet; neurological conditions such as motor neuron disease, brain tumour, Parkinson's disease or as a result of a brain injury. Surgical conditions such as preoperative or postoperative surgery, burns, or pancreatitis; a psychiatric issue like anorexia nervosa; or disorder such as cystic fibrosis may also require enteral feeding.

Some of the problems with current technology used in enteral feeding include the noise and vibrations of the pump used to deliver the liquid formula, the difficulty that users can experience when setting up the pump and, most importantly, the restriction to the persons mobility. Conventional feeding systems involve pumps which are battery or electronically powered. Noise and vibrations are produced which can be very disturbing, especially when trying to sleep at night. When feeding at home, patients are required to be lying down or seated, then the pump is placed on an IV type stand with the bag held higher over the pump. A single serving of approximately 500 ml to 1000 ml can take from 4 to 24 hours to be administrated, but this is entirely dependent of the patient, as ingestion of feed too fast can lead to stomach pains or vomiting, and releasing the formula too slowly will have less effect and leave the patient tired and lacking in energy.

It is also necessary to have this setup beside their bed for night feeding. Slower feed rates are generally used at night for a longer release of food for the patient. Patients often find it difficult and irritating, when trying to sleep with the constant noise, vibration and also visual impact (lighting) of the pump.

When a patient is not at home, they are required to use a special carry bag for the pump, formula, tubing and all other equipment needed. The conventional carry bag is approximately the same size of an average backpack. It allows the user to feed, while performing some tasks but it is restrictive. Gravity is required to allow flow from a container for enteral fluid to a pump. The pump also requires an electricity supply and/or a battery pack. The units must also be programmed using a complex interface. The current portable systems are heavy and bulky which means that they are not very mobile and are not discreet.

The present invention is directed towards providing improved enteral feeding systems.

### SUMMARY OF THE INVENTION

We describe an enteral feeding apparatus comprising:
a feeding device comprising:
   a shell defining an internal volume,
   a neck at a proximal end of the shell, and
   a module which is removably insertable into the shell and has a coupler (16) which is releasably engageable with the neck, the module having at a proximal end a spout and at a distal end an expansile reservoir configured to expand when filled to fit within the volume of the shell.

In some preferred examples, the reservoir is elongate, having a substantially straight tubular shape when empty. In some preferred examples, the module coupler has elements for friction fitting with the neck. In some preferred examples, the coupler comprises snap-fitting features for snap-fitting engagement with features of the neck. In some preferred examples, the coupler features comprise a skirt with distally extending tabs. Preferably, the tabs form sockets to receive neck features comprising radial projections.

In some preferred examples, the coupler and the neck are configured for push fitting of the coupler into the neck. In some preferred examples, the coupler and the neck are configured for screw fitting together. In some preferred examples, the spout is configured to act as an inlet or as an outlet.

In some preferred examples, the module comprises a cap for removably fitting to the spout. Preferably, the shell has a viewing window allowing visibility of the reservoir.

In some preferred examples, the shell has graduation markings alongside the window. In some preferred examples, the window is elongate in the proximal-distal direction.

In some preferred examples, the shell has a base to allow it to be free standing. Preferably, the shell is pear shaped, having a circular cross-sectional shape and being wider near to the distal end than the proximal end, and the internal shape and volume are matched to shape of the reservoir when full. In some preferred examples, the module and the shell form a seal when engaged.

In some preferred examples, the shell has a port, and the apparatus comprises a vacuum device for sucking air from a volume between the reservoir and the shell to assist flow of liquid into the reservoir as it expands. In some preferred examples, the vacuum device comprises a housing forming a cradle for the filling device. Preferably, the port is in a base of the shell.

In some preferred examples, the apparatus further comprises a controller for the vacuum device, the controller being configured to stop or decrease suction when a pre-set time has elapsed and/or a pre-set pressure within the shell is detected. Preferably, the shell port has a default closed position.

In some preferred examples, the shell port has a plunger which is biased to a closed position and is adapted to be pushed to an open position when it engages the vacuum device.

In some preferred examples, the reservoir and the shell are configured so that the reservoir contacts the shell port and seals it when the reservoir is full.

In some preferred examples, the vacuum device comprises a cradle for the shell, and a weight activated switch linked to a processor and that is adapted to sense the presence of the shell due to weight of the shell on the cradle, and to activate the vacuum pump.

In some preferred examples, the vacuum pump is configured to de-activate when it senses a demand for excessive power, indicating that the shell port is closed.

We also describe an enteral feeding apparatus comprising a feeding device comprising a shell defining an internal volume, an expandable reservoir linked with an inlet spout, a shell port in the shell, and a vacuum device for sucking air from the volume via said port to assist flow of liquid into the reservoir as it expands. The vacuum device may have any of the features of the apparatus described above. However, it is not essential that the reservoir be removably connectable to the shell.

### Additional Statements

We describe an enteral feeding apparatus comprising:
a feeding device comprising:
   a shell defining an internal volume,
   a neck at a proximal end of the shell, and
   a module which is removably insertable into the shell and has a coupler which is releasably engageable with the neck, the module having at a proximal end a spout and at a distal end an expansile reservoir configured to expand when filled to fit within the volume of the shell.

In some preferred examples, the reservoir is elongate, having a substantially straight tubular shape when empty. In some preferred examples, the module coupler has elements for friction fitting with the neck.

In some preferred examples, the coupler comprises snap-fitting features for snap-fitting engagement with features of the neck. In some preferred examples, the coupler features comprise a skirt with distally extending tabs.

In some preferred examples, the tabs form sockets to receive neck features comprising radial projections. In some preferred examples, the coupler and the neck are configured for push fitting of the coupler into the neck.

In some preferred examples, the coupler and the neck are configured for screw fitting together. In some preferred examples, the spout is configured to act as an inlet or an outlet. In some preferred examples, the module comprises a cap for removably fitting to the spout. In some preferred examples, the shell has a viewing window allowing visibility of the reservoir. In some preferred examples, the shell has graduation markings alongside the window. In some preferred examples, the window is elongate in the proximal-distal direction. In some preferred examples, the shell has a base to allow it to be free standing.

In some preferred examples, the shell is pear shaped, having a circular cross-sectional shape and being wider near to the distal end than the proximal end, and the internal shape and volume are matched to shape of the reservoir when full.

In some preferred examples, the module and the shell form a seal when engaged. In some preferred examples, the shell has a port, and the apparatus comprises a vacuum device for sucking air from a volume between the reservoir and the shell to assist flow of liquid into the reservoir as it expands. In some preferred examples, the vacuum device comprises a housing forming a stand or cradle of the filling device. In some preferred examples, the port is in a base of the shell.

In some preferred examples, the apparatus further comprising a controller for the vacuum device, the controller being configured to stop or decrease suction when a pre-set time has elapsed and/or a pre-set pressure within the shell is detected. In some preferred examples, the shell port has a default closed position.

In some preferred examples, the shell port has a plunger which is biased to a closed position and is adapted to be pushed to an open position when it engages the vacuum device.

We also describe an enteral feeding apparatus comprising a feeding device comprising a shell defining an internal volume, an expandable reservoir linked with an inlet spout, a port in the shell, and a vacuum device for sucking air from the volume via said port to assist flow of liquid into the reservoir as it expands. This apparatus does not necessarily have a modular insert with the spout and reservoir, but it is preferable that it does.

In some preferred examples, the vacuum device is in a stand or cradle of the feeding device. In some preferred examples, the port is in a base of the shell.

In some preferred examples, the shell is generally pear shaped, with a circular cross-section which greater in area in a lower part of the housing, the shell an internal surface conforming to a shape of the reservoir when expanded.

In some preferred examples, the apparatus further comprises a controller for the vacuum device, the controller being configured to stop or decrease suction when a pre-set time has elapsed and/or pre-set pressure within the housing is detected.

### DETAILED DESCRIPTION OF THE INVENTION

The invention will be more clearly understood from the following description of some embodiments thereof, given by way of example only with reference to the accompanying drawings in which:

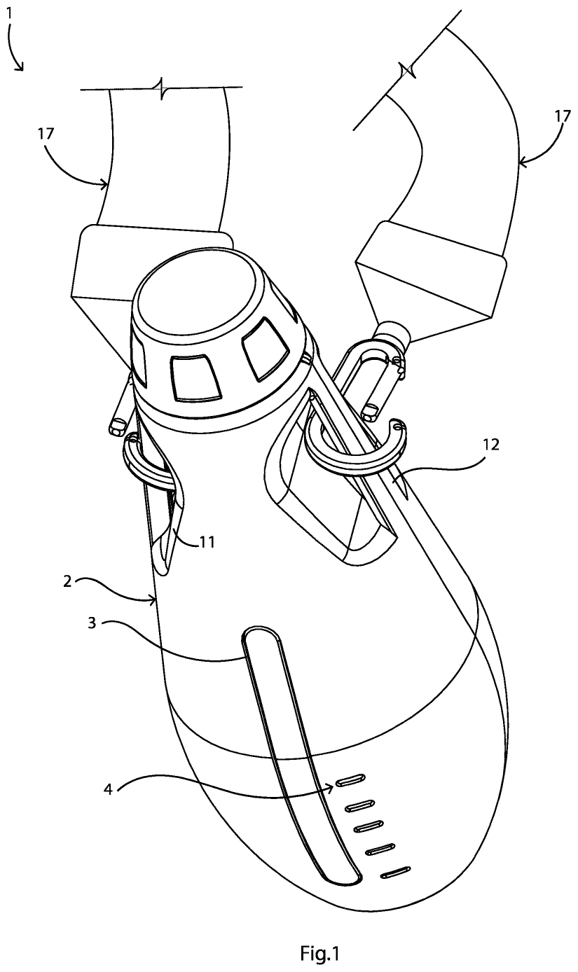

FIG. 1 is a top perspective view of an enteral feeding device,

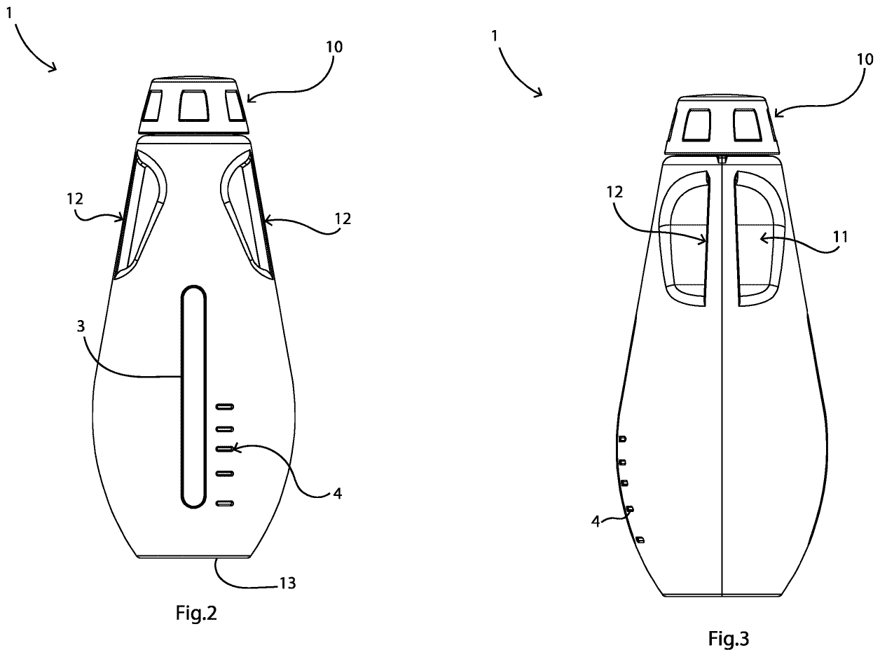

FIGS. 2 and 3 are side views of the device,

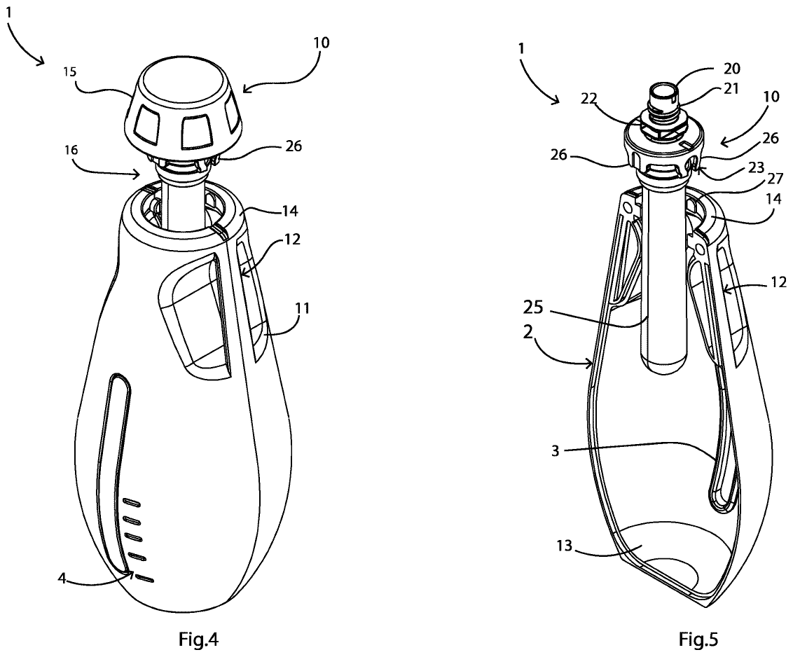

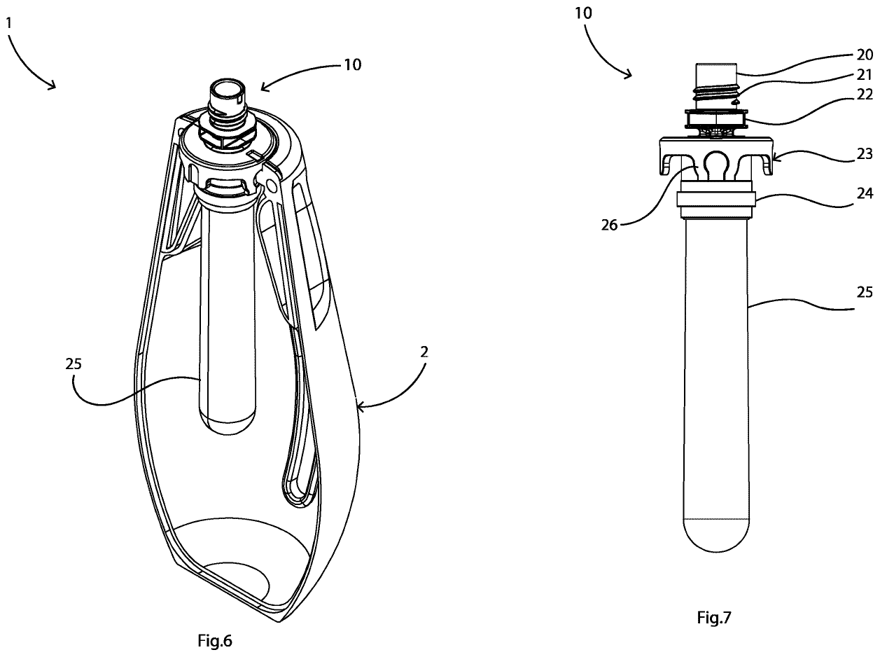

FIG. 4 is a perspective view of the device with a port/reservoir module partly removed,

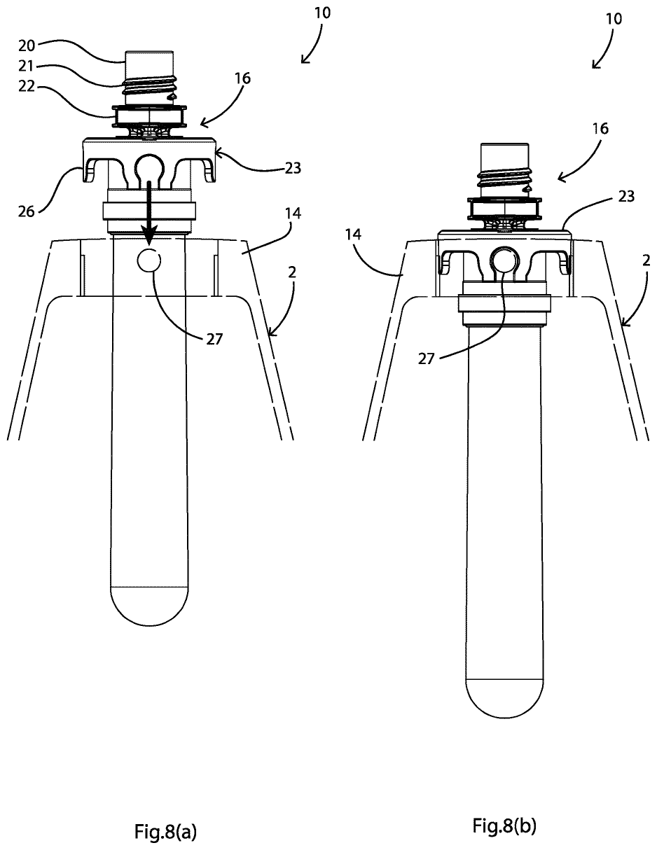

FIGS. 5 and 6 are perspective cut-away views showing the device in more detail, especially an expansile elastomeric reservoir within a shell,

FIG. 7 is a front view of the reservoir and associated port,

FIG. 8(a) and (b) are diagrammatic front views showing coupling of the module to the shell, with a push-fit, and with venting between the module and the shell,

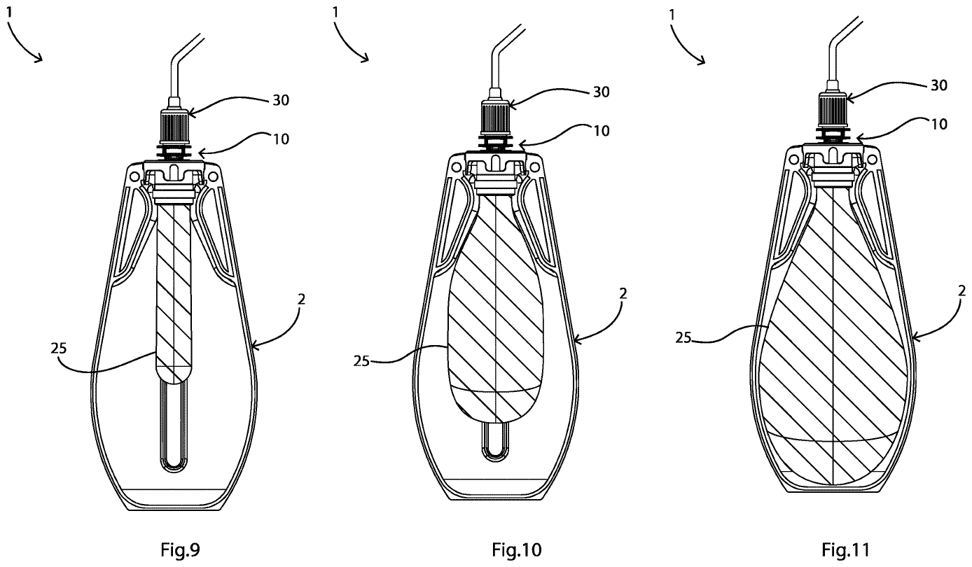

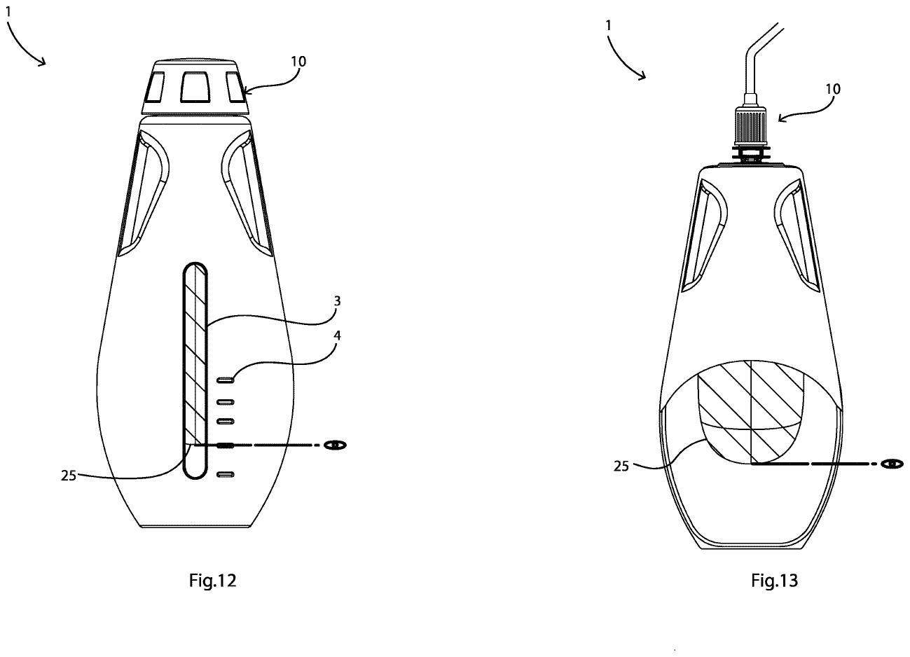

FIGS. 9, 10, and 11 are cut-away front views showing the reservoir being progressively filled until it substantially occupies all of the internal volume of the shell,

FIG. 12 is a front view showing how the quantity of food in the reservoir is visible through a window in the casing, and FIG. 13 is a cut-away view showing the reservoir shape in relation to the casing,

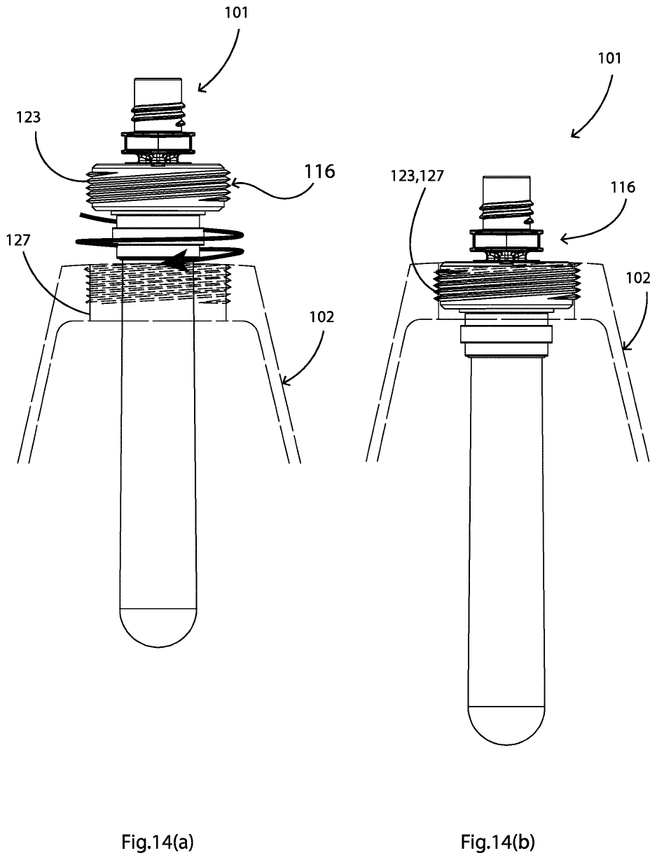

FIG. 14(a) and (b) are diagrammatic front views showing coupling of a module to a shell of an alternative feeding device, in this case with sealing of the module to the neck of the shell,

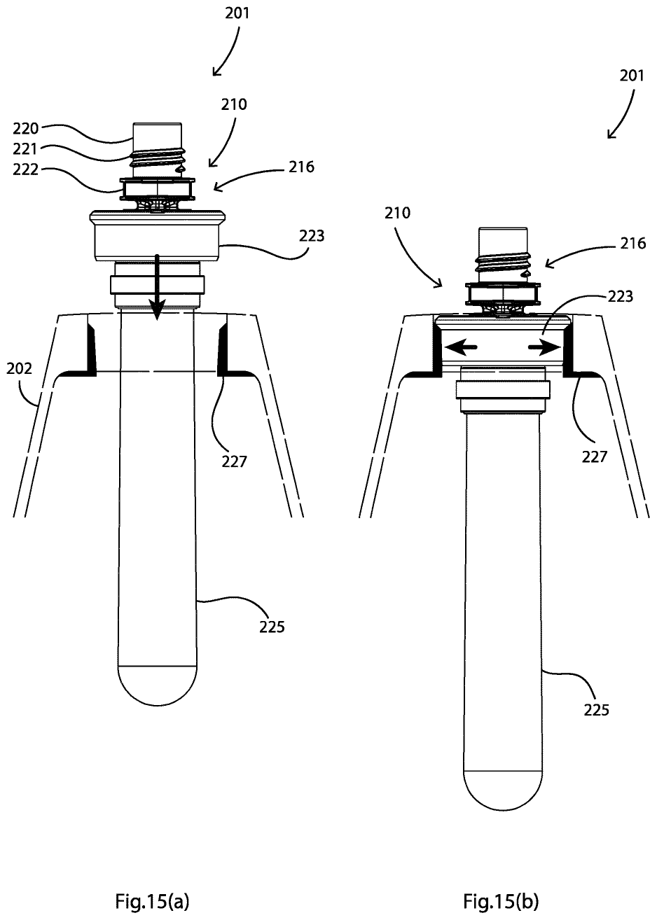

FIG. 15(a) and (b) are diagrammatic front views showing coupling of a module to a shell of another alternative feeding device, again with sealing of the module to the neck of the shell,

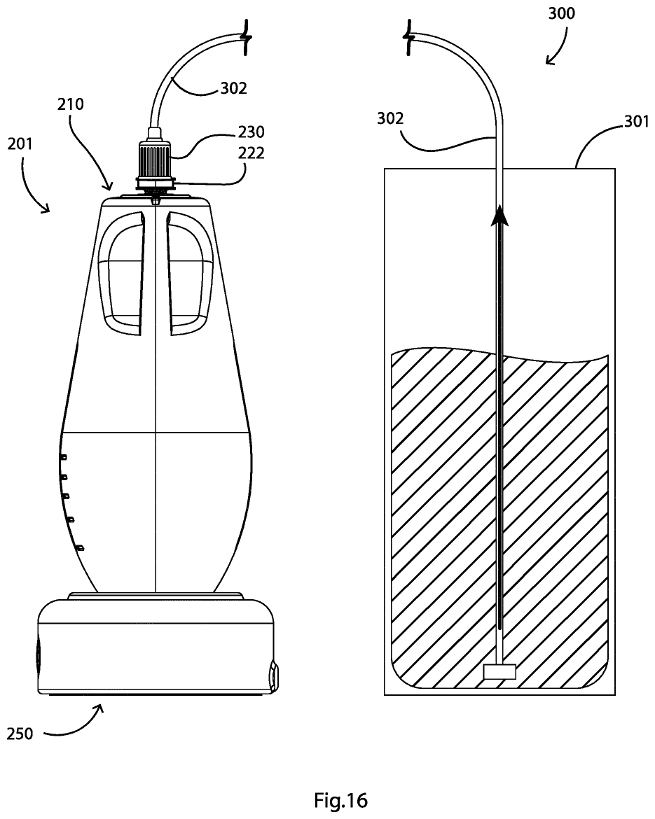

FIG. 16 is a diagrammatic view showing the device of FIG. 15 linked with a filling container and mounted on a vacuum pump to provide pumping force for filling of the device's reservoir from the container,

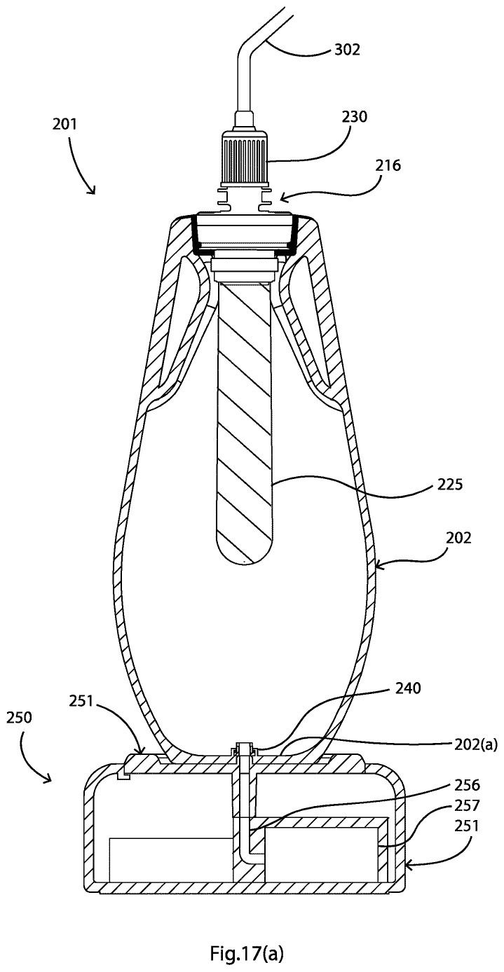

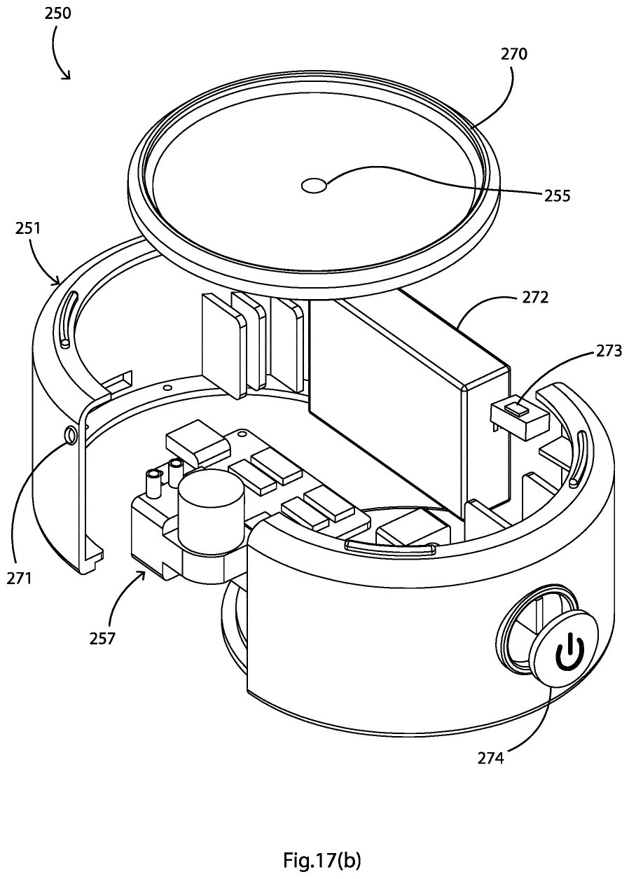

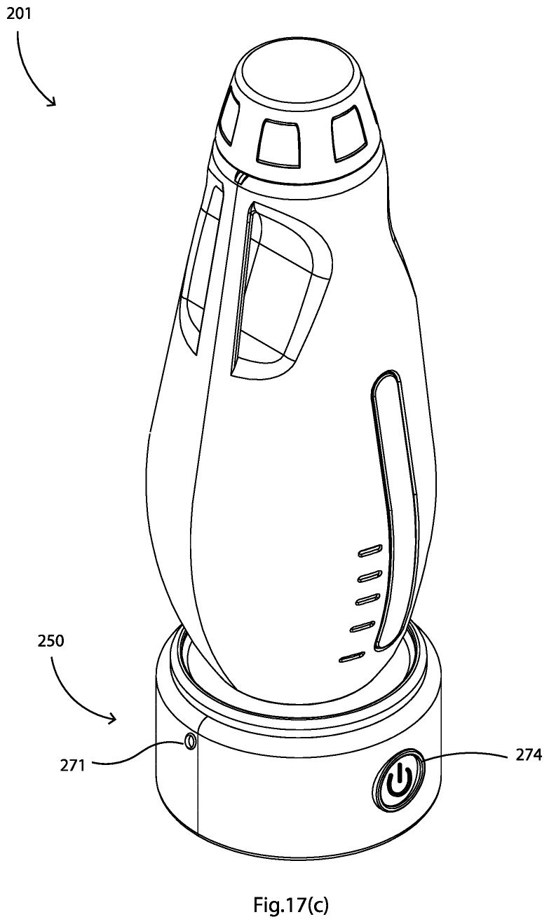

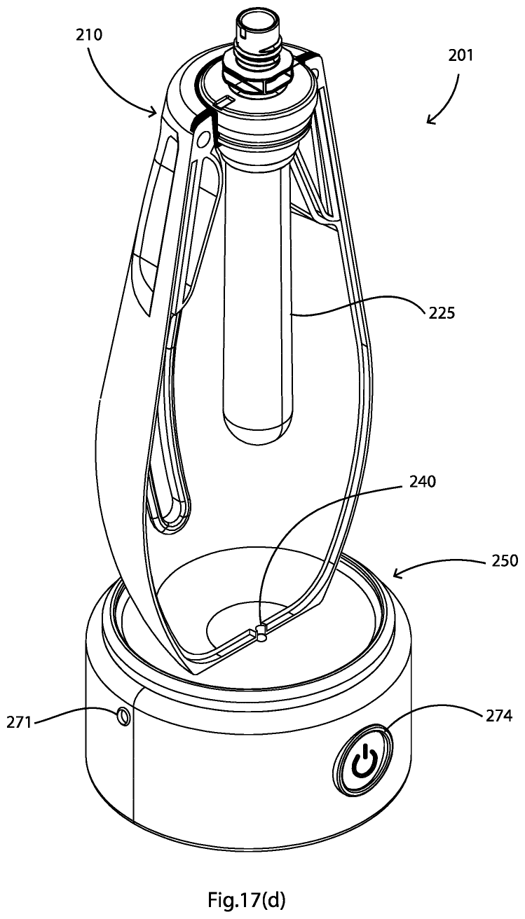

FIG. 17(a) is a front sectional view of the device of FIG. 16, FIG. 17(b) is an exploded view of the pump, FIG. 17(c) is a perspective view of the device, and FIG. 17(d) is a partly cut away perspective view of the device,

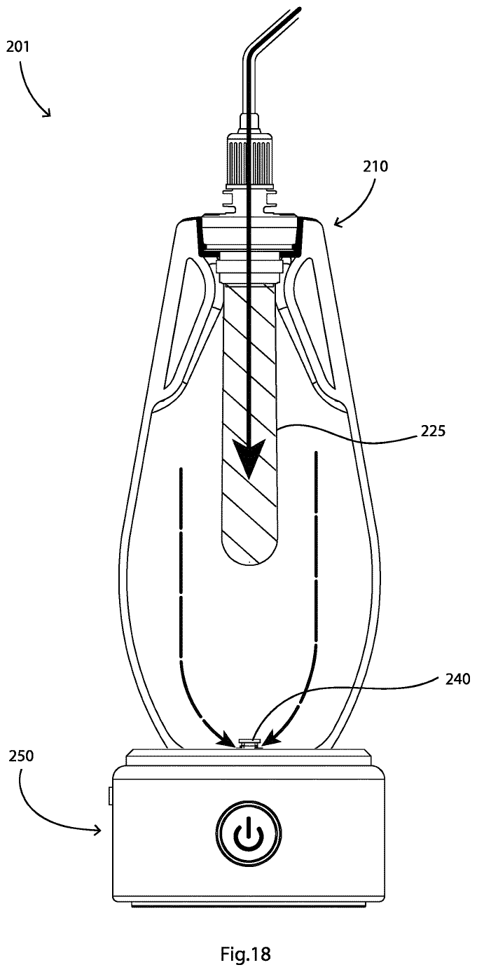

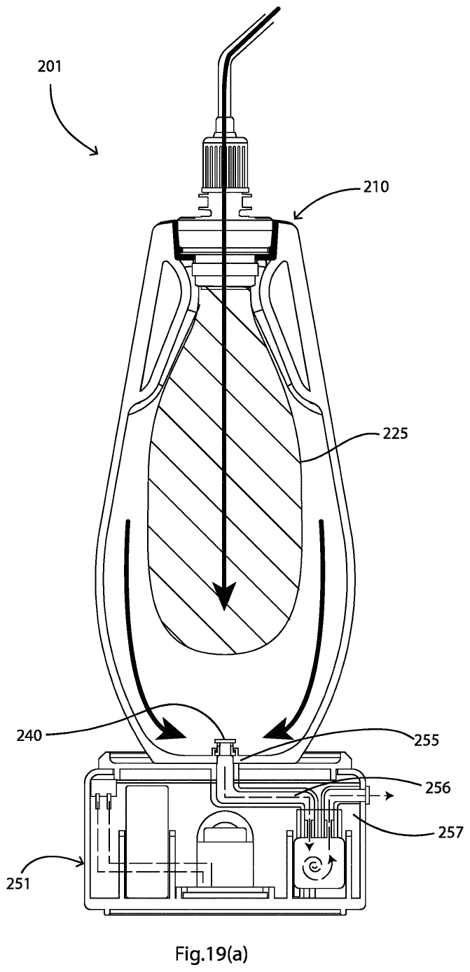

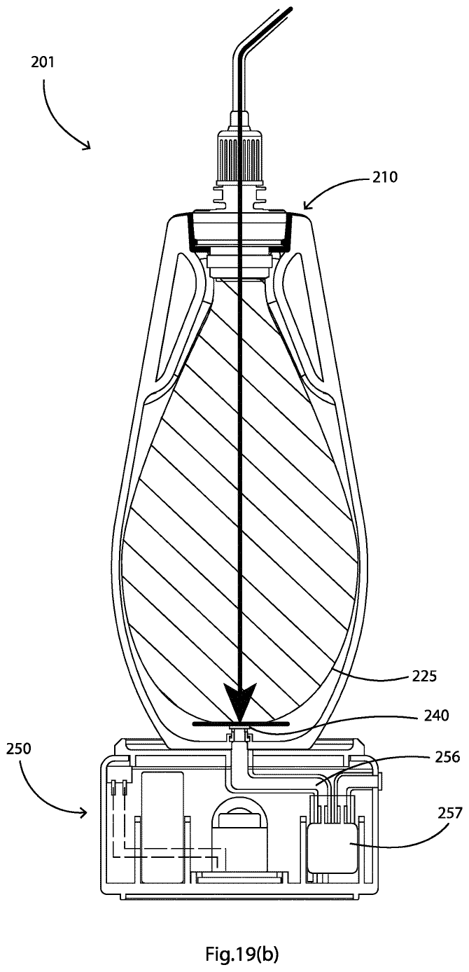

FIGS. 18, 19(a), and 19(b) are sectional views showing three stages of filling the device with use of the vacuum pump,

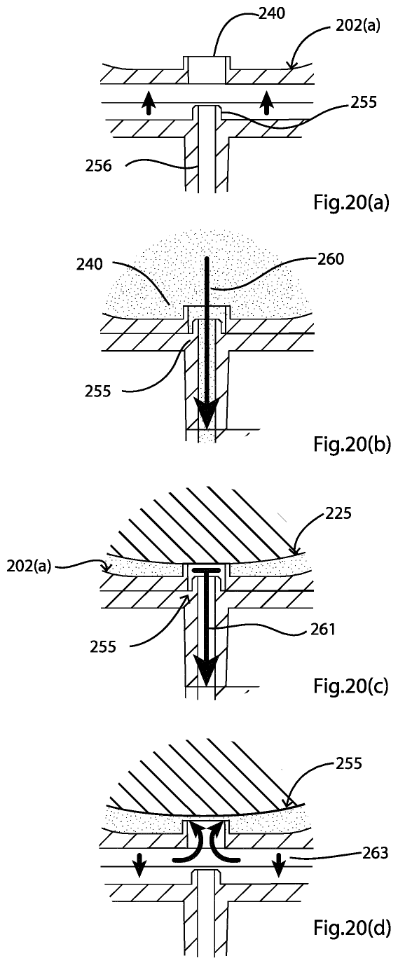

FIG. 20(a), (b), (c), and (d) are sectional views showing in more detail stages of engagement and operation of the device's vacuum pump port and the vacuum pump,

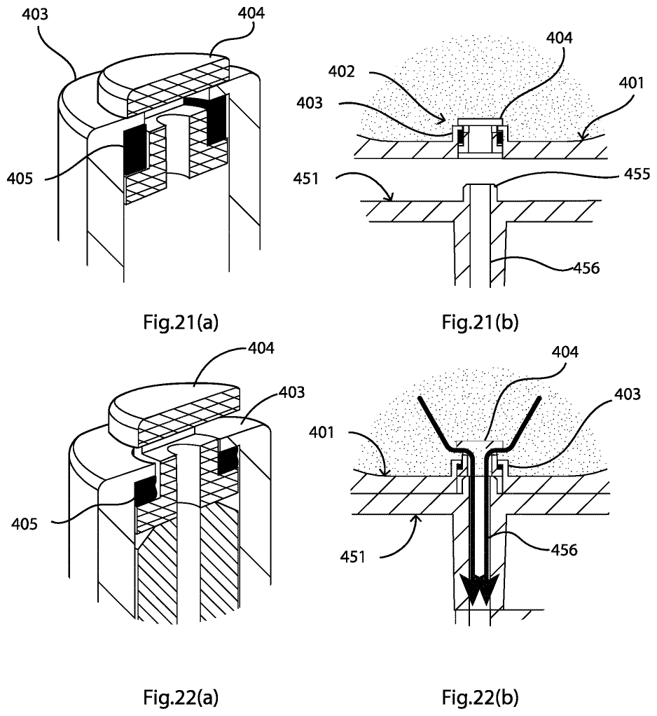

FIG. 21(a) and (b) are perspective and sectional views showing an alternative vacuum pump port in the base of the device, when closed, and FIG. 22(a) and (b) are similar views when the port is open,

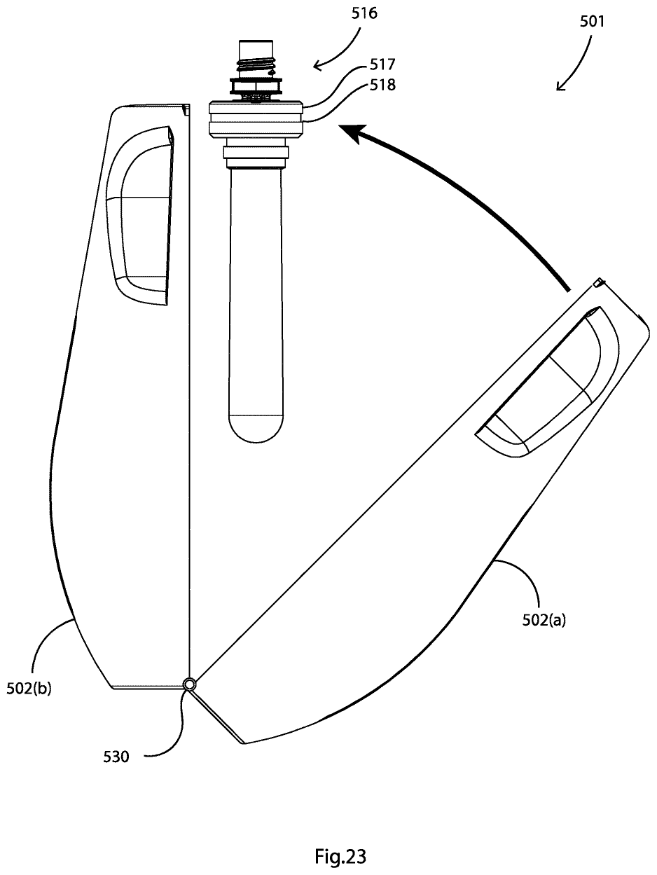

FIG. 23 is a front view of an alternative device, having a shell in two halves hinged together, and

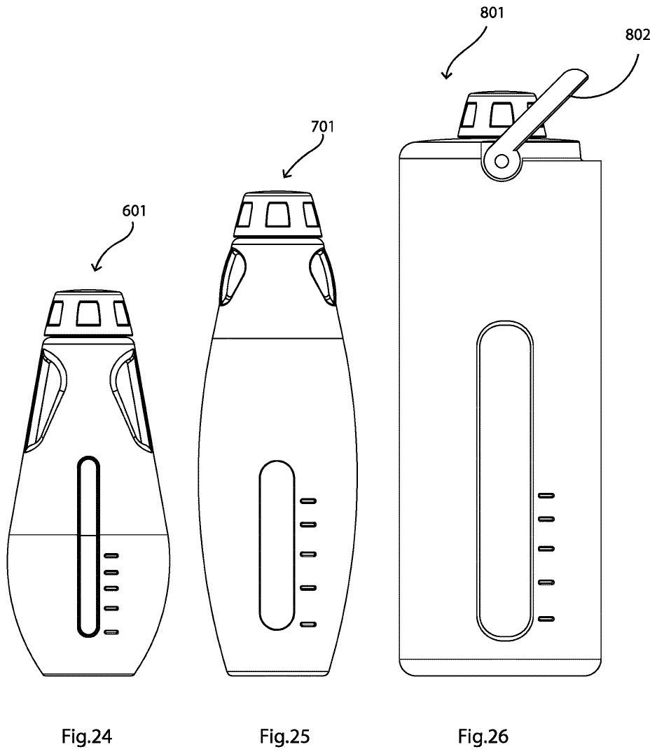

FIGS. 24, 25, and 26 are front views of three alternative devices.

### VENTED FEEDING DEVICE WITH REMOVABLE MODULE

Referring to FIGS. 1 to 13 an enteral feeding device 1 comprises a hard plastics shell 2 with a generally “pear shaped” configuration, having a shape which widens in a direction downwardly from the top and is curved to narrow close to its base. FIG. 1 shows a carrying strap 17 with fasteners attached to opposed handles 12. It is advantageous to have a belt with clips attached to the outer casing. These can be clipped, tied or attached to the outer casing and can be worn over the shoulder, around the waist or by other means.

The shell 2 has a flat base so that it can be free-standing, like a bottle. The shell 2 has a vertical elongate window 3 to allow user visibility inside the shell, to allow viewing of an elastomeric reservoir as it expands/contracts, thereby indicating the enteral food volume during filling/use. There is a scale 4 alongside the window 3. There are a pair of opposed handles 12 which follow the contours of the external surface of the shell, with a recess 11 behind each. These recesses extend into the volume of the shell where the space is available, above the level of an elastomeric reservoir 25. The shell 2 has a neck 14 to which is attached a spout and reservoir module 10. In this specification the direction from the neck towards the body of the shell is distally, the opposite being referred to as proximally.

The removable spout and reservoir module 10 fits into the shell 2 at the neck 14. The module 10 comprises a top cap 15, a releasable coupler 16 incorporating a spout 20 for inlet and outlet of enteral feeding liquid, and an elastomeric expansile reservoir 25. The spout 20 is shrouded by the cap 15 when the device 1 is not in use, and the spout 20 has external threads 21 for engaging the cap 15 when not in use and for engaging a Luer connector when in use.

Distally of the threads 21 there are a pair of rims 22 for manufacturing handling. Distally of the rims 22 there is a resilient skirt 23 with distally extending tabs 26. More distally, there is a rim 24, and more distally there is the expansile reservoir 25.

Insertion of the module 10 is achieved by simply pushing it into the neck 14, and at the final “home” position the tabs 26 snap fit to lugs 27 in the neck 14. This provides a clicking sensation so that the user knows that the module 10 is fully inserted. In this position there is venting allowed through the neck circumferentially between the tabs 26. This is shown most clearly in FIG. 8(a) and (b).

Movement of the module 10 into the shell is also shown in FIGS. 4 to 6. In the inserted position the reservoir 25 can be filled by connection of a Luer connector 30 to the spout 20. As the reservoir 25 is filled it expands as shown in FIGS. 9 to 13, until the reservoir 25 fills the lower, distal, volume of the shell 2. As illustrated in FIGS. 12 and 13 the extent of filling is visible through the window 3. Following filling, the Luer connector is removed, and when required for feeding a Luer connector for a feeding line is connected to the spout 20 of the device. The device 1 may remain at its upright position because the pumping force is provided by the contraction of the reservoir 25.

It is advantageous that the casing and the inner workings of the device are separated. The module couplers and the shell necks provide venting because the module does not have an airtight engagement with the neck as air passes around the tabs 26 to allow air into and out of the space between hard shell and elastomer. This allows effective filling of the reservoir 25 with application of an applicable level of filling pressure. In other embodiments the vent is located elsewhere, for example in the shell itself.

Having a reuseable shell brings down the repeated use cost of the device. Also, it allows excellent choice as multiple feed companies could choose to supply ‘their’ styled shell with different colours/added graphics. The shell can be personalised by users. The shell can be washed for multiple use (more hygienic). Additional features can be implemented into the shell such as handles to allow for the shell to be worn, volume indicators due to transparent parts on the shell. There is improved sustainability, given that only the elastomer and spout would be disposable.

The snap fit configurations allow a user to push in and pull out with a nominal amount of restriction, allowing ease for the user to do so.

The shell configuration mimics the shape of the elastomer when filled and utilizes the elastomer's dimensions. The shell is configured so that the filled elastomer shape and dimensions fit neatly inside the walls of the shell. The form of the shell and the device filling orientation (with the shell standing upright) minimises potential for friction between the shell and the elastomer reservoir walls. Due to the rigid nature of the shell, the reservoir is restricted when being filled and so patients cannot over-fill the device.

### Feeding Devices With Sealing Between the Module and the Shell

FIG. 14(a) and (b) show an alternative device, 101, with a shell 102 and a module 116 having external threads 123 for engaging internal threads 127 in the neck of the shell 102. In this case there is sealing between the module and the neck, by a gasket, not shown.

There may be a twist and lock arrangement, which would not require a pitch to the thread, it would be a push to endpoint and a single twist of approximately 90°.

FIG. 15(a) and (b) show a device 201 with a module 210 having a coupler collar 223 which fits by axial distal movement until the collar 223 friction fits with a neck 227 internal surface. In this case most of the resilience is provided by the neck 227, especially as it has a resilient liner, and there is again sealing between the module and the neck. These diagrams show a shell 202 and a reservoir 225 which are similar to the shell 2 and the reservoir 25 respectively. Also, there is a rim 222 for handling during assembly/manufacture, and a spout 220 with threads 221 for connection to a Luer connector 230 or a cap when not in use.

Where there is sealing at the neck, as in FIGS. 14 and 15, the filling may be driven by a vacuum pump which creates a vacuum between the reservoir and the shell. If this is the case the device still has the advantages set out above for the device 1, for example in terms of the shape of the shell relative to the expansile reservoir. It is not essential that there be a module which is inserted and forms a seal with the shell. For example, the spout and the reservoir may be permanently connected to the shell, and this may still benefit from the vacuum pumping arrangement described below. However, it is preferred that the device be modular.

Referring to FIGS. 16 to 20 an enteral feeding apparatus comprises the feeding device 201 and a vacuum pump 250 engaging a port 240 in a base 202(a) of the device shell 202. FIG. 16 shows a filling apparatus comprising a container 301 and a filling tube 302 linked with the Luer connector 230 on the module 210.

The base 202(a) is adapted for engagement with the vacuum pump 250, which has a housing 251 which has a cradle 270 for the device 201. The cradle 270 has an inlet port 255 linked by a conduit 256 to a pump 257 which is in turn linked with a vent 271 in the pump housing 251. There is a switch 273 positioned under the cradle 270, so that when the enteral feeding device 1 is placed in the cradle 270 the cradle is pushed onto the switch 273. This causes the vacuum pump 257 to be activated. Likewise, when the enteral feeding device 1 is removed, the cradle 270 is not pressing on the switch 273 and the vacuum pump 257 will stop.

A user ON/OFF switch 274 is to power ON/OFF the device. A rechargeable battery 272 is provided in the housing 251.

The pump 250 indirectly provides the pumping force to allow liquid to be drawn from the supply container 301 and through the tube 302 with an end immersed in liquid in the container 301 and the other end engaging the Luer connector 230. As is clear from FIG. 17(a) to (d) the shell 202 is conveniently supported on the cradle 270, and this provides nesting engagement of the ports 240 and 255.

As shown in FIGS. 18, 19(a), and 19(b) the vacuum pump 257 draws air from the space between the shell 202 and the reservoir 225, thereby creating a vacuum. The vacuum assists the elastomeric reservoir 225 to expand and to draw the liquid from the supply chamber and into the reservoir 225. The vacuum pump 250 sucks air from the space between the shell 202 and the reservoir 225, thereby assisting the reservoir 225 to expand and fill the volume within the shell 202 from the filling container 301.

When the device 201 is connected as shown in FIGS. 17 to 19 and the vacuum pump 257 is actuated, the vacuum that is created in the space between the reservoir 225 and the shell 202 acts to pull liquid from the supply container 301 and through the supply tube 302 and into the expanding reservoir 225. When the reservoir has filled to its maximum extent to fill the shell, the port 240 is sealed by the reservoir 225.

FIG. 19(a) shows the vacuum continuing to be pulled from the rigid outer casing and the elastomeric reservoir 225 in an expanding state. FIG. 19(b) shows the elastomeric reservoir 225 in a fully expanded state, at which it covers the outlet port 240. With simple programming by measuring the power required to pull negative pressure, the vacuum module 250 can turn off when the elastomeric reservoir is filled fully. The pump is of the type which stops operating when an excessive level of power is required, as happens when the port 240 is sealed by the reservoir 225 being full.

FIG. 20(a) to (d) show operation of the port 240 in the shell base 202(a). The port 240 is simply an opening with a rim, which is only closed when it engages a port 240 of the vacuum pump 250. The vacuum pump port 240 is linked by the conduit 256 to the vacuum pump 257 in the housing 251. As shown, air is drawn out of the shell 202 in the direction of the arrow 260 but stops when the reservoir 225 engages the port 240, with further air withdrawal being blocked as shown by the arrows 261 and 263.

The vacuum fill method is a simple method of filling the elastomeric pump reservoir 225. As a rigid leak-proof chamber, the outer shell 202 can be treated as an airtight chamber. When a vacuum is pulled within the chamber, the elastomeric reservoir 225 fills the chamber due to the elastic properties of the material. Advantages of this method include that there being no food contact and no need to wash components.

The hardware is relatively simple with a vacuum component and means of powering the vacuum component. The negative pressure required to expand the elastomer is relatively low. Filling takes approximately 40 seconds for a 500 ml elastomeric reservoir, with a vacuum power of 0.4 W. The minimum negative pressure required for filling the elastomer is approximately −0.2 Bar. There may be an automatic stop function when the elastomer reaches its intended volume of fill.

As shown in FIG. 21(a) and (b) and 22(a) and (b) an alternative device base 401 has a port 402 with a rim 403 and a plunger 404 which rises to open the port and falls to engage the rim to close the port. The plunger 404 is acted upon by a helical spring 405, which provides a bias force to a lower, closed, position. The vacuum pump 450 has a corresponding port 455 communicating with an air conduit 456 and in turn linked with a vacuum pump akin to the pump 457. The arrangement of FIGS. 21 and 22 is a non-return type valve that holds the negative pressure after the vacuum module is removed, whereas the arrangement of FIG. 20 is to not hold the negative pressure in the shell after removal of the vacuum module.

FIG. 23 shows an alternative arrangement, in which a device 501 has a split shell 502 with equal parts 502(a) and (b) hinged about a pivot joint 530 across the base. The parts close together to encompass a coupler 517 of a module 516, particularly a circumferential groove 518 of the coupler 517. Where the shell has a mechanism to open out this can allow the user to open and place the elastomer/spout assembly module into the shell and then close the shell. An additional advantage is that the module may be easily removed in case of blocking. This arrangement provides a seal at the neck of the shell, however in other embodiments a shell arrangement may be provided to form a non-sealing module/neck.

FIGS. 24, 25, and 26 show devices 601, 701, and 801 respectively, which have the above-described features, but in different shapes for 330 ml, 500 ml and 1 litre respectively. The device 801 is cylindrical and does not have opposed fixed handles, rather a pivotable handle 802 at the top. The arrangements of FIGS. 23 to 26 may be adapted to have seals at their necks and to be suitable for vacuum pumping for filling, or they may be vented for positive pressure filling (as for FIGS. 1 to 13).

Components of embodiments can be employed in other embodiments in a manner as would be understood by a person of ordinary skill in the art. The invention is not limited to the embodiments described but may be varied in construction and detail. For example, the vacuum-driven filling may be performed with a different device, possible having an elastomeric reservoir which is not part of a modular insert within the shell. It may for example be permanent.

1. An enteral feeding apparatus comprising:
a feeding device comprising:
a shell defining an internal volume,
a neck at a proximal end of the shell, and
a module which is removably insertable into the shell and has a coupler which is releasably engageable with the neck,
wherein the module comprises at a proximal end a spout and at a distal end an expansile reservoir configured to expand when filled to fit within the volume of the shell,
wherein the module and the shell form a seal when engaged.

2. An enteral feeding apparatus as claimed in claim 1, wherein the reservoir is elongate, having a substantially straight tubular shape when empty.

3. An enteral feeding apparatus as claimed in claim wherein the module coupler has elements for friction fitting with the neck.

4. An enteral feeding apparatus as claimed in claim 1, wherein the coupler comprises snap-fitting features for snap-fitting engagement with features of the neck.

5. An enteral feeding apparatus as claimed in claim 14, wherein the coupler comprises snap-fitting features for snap-fitting engagement with features of the neck; and wherein the coupler features comprise a skirt with distally extending tabs, wherein the tabs form sockets to receive neck features comprising radial projections.

6. (canceled)

7. An enteral feeding apparatus as claimed in claim 1, wherein the coupler and the neck are configured for push fitting of the coupler into the neck.

8. An enteral feeding apparatus as claimed in claims wherein the coupler and the neck are configured for screw fitting together.

9. An enteral feeding apparatus as claimed in claim 1, wherein the spout is configured to act as an inlet or an outlet.

10. An enteral feeding apparatus as claimed in claim 1, wherein the module comprises a cap for removably fitting to the spout.

11. An enteral feeding apparatus as claimed in claim 1, wherein the shell has a viewing window allowing visibility of the reservoir, and wherein the shell has graduation markings alongside the window, and the window is elongate in the proximal-distal direction.

12. (canceled)

13. (canceled)

14. An enteral feeding apparatus as claimed in claim 1, wherein the shell has a base to allow it to be free standing, and wherein the shell is pear shaped, having a circular cross-sectional shape and being wider near to the distal end than the proximal end, and the internal shape and volume are matched to shape of the reservoir when full

15. (canceled)

16. (canceled)

17. An enteral feeding apparatus as claimed in claim 1, wherein the shell has a port and the apparatus comprises a vacuum device for sucking air from a volume between the reservoir and the shell to assist flow of liquid into the reservoir as it expands.

18. An enteral feeding apparatus as claimed in claim 1, wherein the shell has a port, and the apparatus comprises a vacuum device for sucking air from a volume between the reservoir and the shell to assist flow of liquid into the reservoir as it expands; and
wherein the vacuum device comprises a housing forming a cradle for the filling device.

19. An enteral feeding apparatus as claimed in claim 1, wherein the port is in a base of the shell.

20. An enteral feeding apparatus as claimed in claim 1, wherein:
the shell has a port,
the apparatus comprises a vacuum device for sucking air from a volume between the reservoir and the shell to assist flow of liquid into the reservoir as it expands; the apparatus further comprises a controller for the vacuum device, the controller being configured to stop or decrease suction when a pre-set time has elapsed and/or a pre-set pressure within the shell is detected; and
the shell port has a default closed position.

21. (canceled)

22. An enteral feeding apparatus as claimed in claim 1, wherein:
the shell has a port,
the apparatus comprises a vacuum device for sucking air from a volume between the reservoir and the shell to assist flow of liquid into the reservoir as it expands; the apparatus further comprises a controller for the vacuum device, the controller being configured to stop or decrease suction when a pre-set time has elapsed and/or a pre-set pressure within the shell is detected;
the shell port has a default closed position;
the shell port has a plunger which is biased to a closed position and is adapted to be pushed to an open position when it engages the vacuum device; and
the reservoir and the shell are configured so that the reservoir contacts the shell port and seals it when the reservoir is full.

23. (canceled)

24. An enteral feeding apparatus as claimed in claim 1, wherein:
the shell has a port, and
the apparatus comprises a vacuum device for sucking air from a volume between the reservoir and the shell to assist flow of liquid into the reservoir as it expands; the vacuum device comprises a cradle for the shell, and a weight activated switch linked to a processor and that is adapted to sense the presence of the shell due to weight of the shell on the cradle, and to activate the vacuum pump; and
the vacuum pump is configured to de-activate when it senses a demand for excessive power, indicating that the shell port is closed.

25. (canceled)

26. An enteral feeding apparatus comprising:
a feeding device comprising a shell defining an internal volume,
an expandable reservoir linked with an inlet spout,
a shell port in a base of the shell,
a cradle for the feeding device,
a vacuum device in said cradle, and the vacuum device being configured for sucking air from a volume via said port to assist flow of liquid into the reservoir as the reservoir expands.

27. (canceled)

28. (canceled)

29. An enteral feeding apparatus as claimed in claim 26, wherein the shell has a circular cross-section which is greater in area in a lower part of the housing, the shell an internal surface conforming to a shape of the reservoir when expanded.

30. An enteral feeding apparatus as claimed in claim 26, wherein the apparatus further comprises a controller for the vacuum device, the controller being configured to stop or decrease suction when a pre-set time has elapsed and/or a pre-set pressure within the housing is detected,
wherein the reservoir and the shell are configured so that the reservoir contacts the shell port and seals it when the reservoir is full,
wherein the vacuum device comprises a cradle for the shell, and comprises a weight activated switch linked to a processor and that is adapted to sense the presence of the shell due to weight of the shell on the cradle, and to activate the vacuum pump, and
wherein the vacuum pump is configured to de-activate when it senses a demand for excessive power, indicating that the shell port is closed.

31. (canceled)

32. (canceled)

33. (canceled)
